(19) United States
(12) Patent Application Publication
(10) Pub. No.: US 2008/0056231 A1
(43) Pub. Date: Mar. 6, 2008

(54) Unified Access Communication Network

(76) Inventor: Paul Langner, Fremont, CA (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/465,226

(22) Filed: Aug. 17, 2006

(51) Int. Cl. H04L 12/66

(52) U.S. Cl. 370/352

(57) ABSTRACT

The invention is, in one embodiment, a network switching system having control circuitry and one or more ports. The control circuitry provides packet-switched-network, e.g., Ethernet, services to one or more network client devices. The control circuitry further provides analog-telephone services to one or more telephonic client devices. Each port connects to one or more client devices, wherein at least one port supports provision of both packet-switched-network services and analog-telephone services to support a network client device, a telephony client device, or both simultaneously.

### BACKGROUND OF THE INVENTION

1. Field of the Invention

The present invention relates to communication networks and equipment, and more particularly to wired office communication networks and equipment.

2. Description of the Related Art

Wired communication network equipment in an office can include, for example, server computers, client computers, network hubs, network switches, network routers, VoIP (voice over IP) telephones, and other telephones. Wired devices can also have wireless capabilities. Thus, for example, a wireless hot-spot device can, in a typical configuration, communicate with a server device via a wire and with one or more wireless client devices wirelessly. One popular data networking standard for offices is the Ethernet standard, particularly in its star-topology, twisted-pair-wiring form. In a simple star-topology twisted-pair-wiring network, a central server communication device is connected to several client communication devices via twisted-pair wires.

The server communication device also is typically connected to an external communication network, such as the Internet. One popular system for telephonic communication for offices is a private branch exchange (PBX). A PBX typically includes a central server computer and individual phones and other communication devices (e.g., fax machines) functioning as client communication devices. The PBX connects to an external telephone communication network, such as the public switched telephone network (PSTN) to allow the client communication devices to connect with client communication devices elsewhere.

In a typical office setup, a client device connects to a proximate communication socket using a twisted-pair wire terminated with a connector plug, such as an RJ45 or an RJ11 plug. Twisted-pair wires run from the sockets, through the office infrastructure, to the back of a patch panel located proximate to a central server device. Sockets on the front of the patch panel allow connections from the wires in the back of the patch panel to other wires, the central server device, and/or other networking equipment. Thus, the patch panel serves as a wiring hub proximate to the central server device. Similar arrangements are used for a data network and a voice-communication network in a typical office.

FIG. 1 shows a simplified diagram of prior-art unified access network 100. The central portion of network 100 comprises switching system 101. Switching system 101 is connected via paths 101a to one or more computers such as workstation 102 and server 103. Switching system 101 is also optionally connected via paths 101a to one or more wireless hubs such as wireless hub 104 and 105. The term “hub” as used herein refers to a device's most basic function as a network connection node and, unless explicitly indicated, is not intended to limit the particular device's functionality to that basic level. Thus, wireless hub 104 can, for example, function as a wireless switch or router.

FIG. 2 shows a simplified block diagram of an implementation of switching system 101 of the network of FIG. 1 in a Power-over-Ethernet (PoE) system. Switching system 101 comprises Ethernet switch 207 and wireless coprocessor 208. Ethernet switch 207 can be implemented, for example, by a Gigabit Ethernet switch of the ET4K series from Agere Systems, Inc. (“Agere”) of Allentown, Pa. ET4K series switches can support up to 48 ports.

Wireless coprocessor 208 is adapted to operate as a firewall for data coming in from wireless hubs to Ethernet switch 207. Switching system 101 further comprises control processor 209, which regulates the operation of Ethernet switch 207 and wireless coprocessor 208. Control processor 209 may also perform additional functions, such as user authentication or other firewall-related functions.

Ethernet switch 207 is connected to multiple RJ45 interface ports, such as ports 212 and 215, via corresponding physical-layer devices (PHY), such as PHYs 210 and 213, respectively, and via corresponding PoE transformers, such as PoE transformers 211 and 214, respectively, which inject DC power from PoE power sourcing equipment (PSE) 216. Dashed arrow 216a indicates a connection from PSE 216 to PoE transformer 211, as well as connections from PSE 216 to additional PoE transformers (not shown). PHYs 210 and 213 can be implemented, for example, using the ET1081 octal PHY from Agere, which comprises eight individual PHYs, and could therefore support six additional PHYs (not shown). The path from RJ45 interface 212 to PHY 210 comprises four wire pairs, as does the path from RJ45 interface 215 to PHY 213.

PHY device 210 functions as the physical-layer interface between signals to/from Ethernet switch 207 and signals from/to RJ45 interface 212. PoE transformer 211 is adapted to transmit data between PHY device 210 and RJ45 interface 212. PoE transformer 211 is further adapted to provide DC power from PoE PSE 216 through RJ45 interface 212 to a PoE-compliant powered device (not shown), such as a wireless hub, which is connected to RJ45 interface 212 via appropriate connections. PHY 213, RJ45 interface 215, and PoE transformer 214 are adapted to function in the same way as PHY 210, RJ45 interface 212, and PoE transformer 211, respectively.

### SUMMARY OF THE INVENTION

In one embodiment, the invention is a network switching system comprising control circuitry and one or more ports. The control circuitry, in the present embodiment, is adapted to: (i) provide packet-switched-network services to one or more network client devices, and (ii) provide analog-telephone services to one or more telephonic client devices. Each of the one or more ports is adapted to connect to one or more client devices, wherein at least one port is adapted to support provision by the control circuitry of both packet-switched-network services and analog-telephone services.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of a prior-art office communication network.

FIG. 2 shows a simplified block diagram of an implementation of the switching system of the network of FIG. 1.

FIG. 3 shows a simplified block diagram of an office communication network in accordance with one embodiment of the present invention.

FIG. 4 shows a simplified block diagram of switching system 401, which can be used to implement switching system 301 of FIG. 3, in accordance with one embodiment of the present invention.

FIG. 5 shows a simplified block diagram of switching system 501, which can be used to implement switching system 301 of FIG. 3, in accordance with one embodiment of the present invention.

FIG. 6 shows a simplified block diagram of switching system 601, which can be used to implement switching system 301 of FIG. 3, in accordance with one embodiment of the present invention.

FIG. 7 shows a simplified block diagram of switching system 701, which can be used to implement switching system 301 of FIG. 3, in accordance with one embodiment of the present invention.

FIG. 8 shows a simplified block diagram of switching system 801, which can be used to implement switching system 301 of FIG. 3, in accordance with one embodiment of the present invention.

FIG. 9 shows a simplified block diagram of switching system 901, which can be used to implement switching system 301 of FIG. 3, in accordance with one embodiment of the present invention.

FIG. 10 shows a simplified block diagram of an implementation of a client-side splitter in accordance with an embodiment of the present invention.

### DETAILED DESCRIPTION

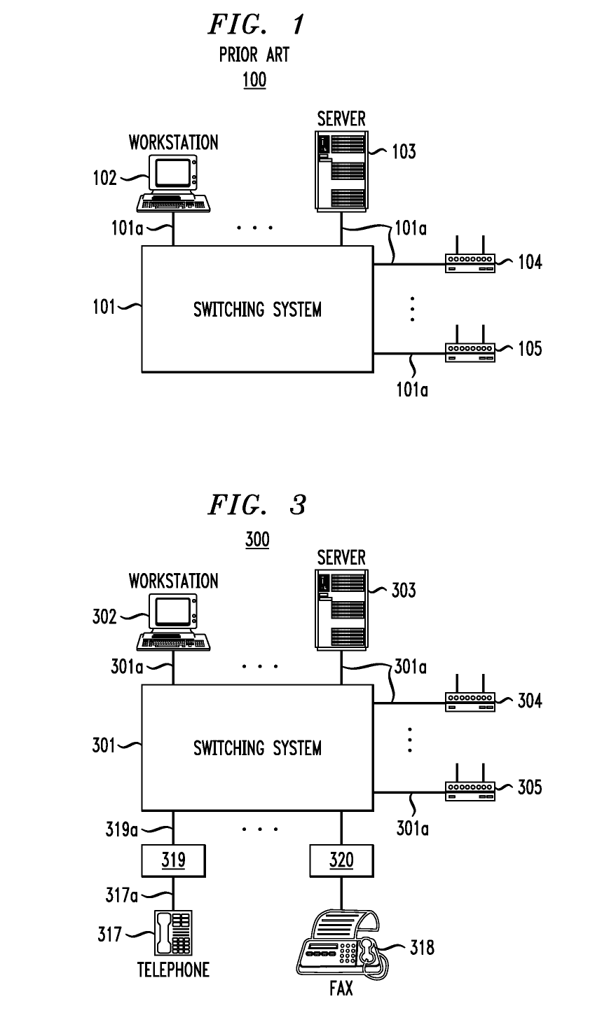

FIG. 3 shows a simplified block diagram of the switching system of a network in accordance with one embodiment of the present invention. Elements in FIG. 3 that are similar to elements in FIG. 1 have corresponding labels, but with different prefixes. Switching system 301 is connected to computers, servers, and hubs, similar to the connections of switching system 101 of FIG. 1. Switching system 301 is further connected to client telephonic equipment such as telephone 317 and fax machine 318.

Computer 302, server 303, and hubs 304 and 305 connect to switching system 301 using an RJ45 interface. Client telephonic equipment such as telephone 317 and fax machine 318 connect to switching system 301 using RJ11-to-RJ45 interfaces such as sockets 319 and 320, respectively. Similar wires and connections bridge the path from switching system 301 to all the communications sockets, whether the communication socket is used by computer 302, server 303, hubs 304 and 305, telephone 317, or fax machine 318. These communication sockets are adapted to accept RJ45 plugs. The standardization of infrastructure communication wiring and connections may reduce costs and simplify communication infrastructure maintenance and repair.

As is known in the art, a six-position RJ11 plug will fit and snap into the center of an eight-position RJ45 socket, which is typically used with the eight-position RJ45 plug. A plug generally may have a number of pins and/or conductors up to the number of positions of the plug. Telephone 317 contains an RJ11 socket, and telephone 317 connects to RJ45 socket 319 via wire 317a, which is terminated with RJ11 plugs at both ends. One RJ11 plug of wire 317a plugs into the RJ11 socket of telephone 317, and the other RJ11 plug of wire 317a plugs into RJ45 socket 319. RJ45 socket 319 is then connected to switching system 301 through infrastructure wiring 319a, as described in the background section for a typical office setup. Fax machine 318 is similarly connected to switching system 301 via an RJ11 wire, RJ45 socket 320, and infrastructure wiring.

Switching system 301 includes components (not shown) to support voice communication with telephone 317 and fax machine 318, as well as data communication with computer 302, server 303, and wireless hubs 304 and 305. Switching system 301 acts as a VoIP transformer for telephone 317 and fax machine 318. Thus, switching system 301 communicates with telephone 317 and fax machine 318 using the analog telephone communication standard, and translates analog telephone signals into digital packet-switched data as in the VoIP standard. Switching system 301 can connect telephone calls to/from telephone 317 and fax machine 318 using Internet telephony, or switching system 301 can connect to a telephone company central office using a dedicated packet-switched connection. Alternatively, switching system 301 can connect to the public switched telephone network (PSTN) using any suitable connection means.

Switching system 301 can be configured so as to appropriately identify the client device on a particular port as a telephonic client device or a network client device. Alternatively, switching system 301 can be configured to automatically detect the connection of a client device and identify it as a telephonic client device or a network client device. Automatic identification may be accomplished, for example, by a combination of (i) detecting a telephone's characteristic ringer circuit impedance, and (ii) detecting an Ethernet device with link-test pulses.

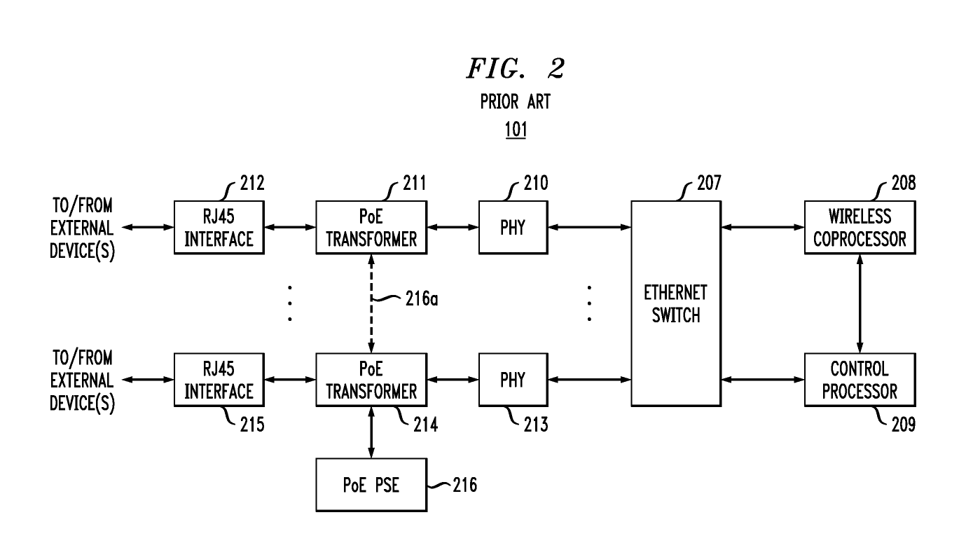

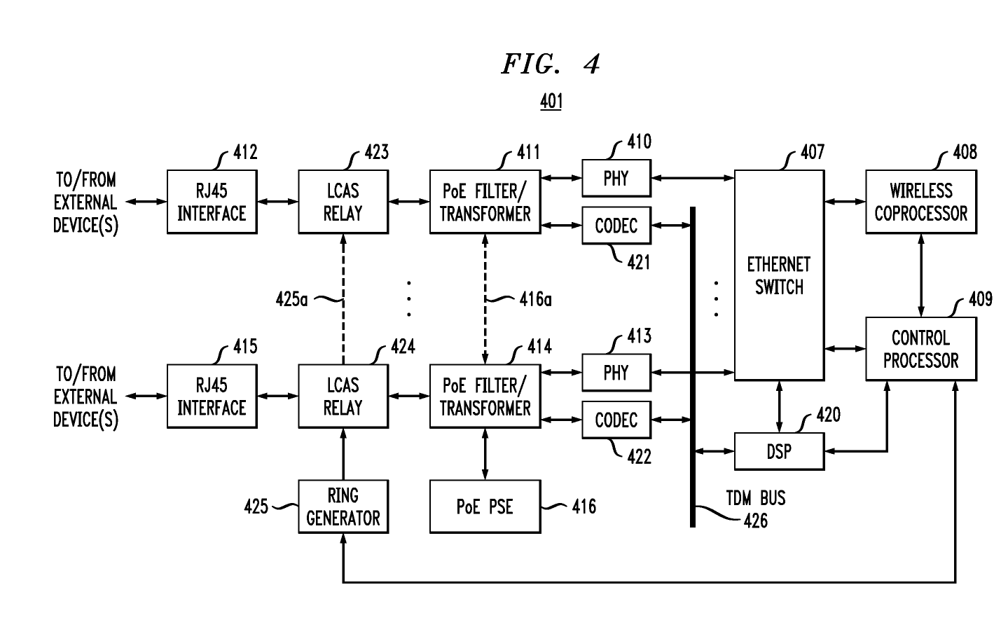

FIG. 4 shows a simplified block diagram of switching system 401, which can be used to implement switching system 301 of FIG. 3, in accordance with one embodiment of the present invention. Elements in FIG. 4 that are similar to elements in FIG. 2 have corresponding labels, but with different prefixes. This switching system 401 includes Ethernet switch 407, wireless coprocessor 408 and control processor 409, which operate similarly to the corresponding elements in FIG. 2. This Ethernet switch 407 is adapted to function as a packet controller providing packet-switched-network services. Switching system 401 also includes DSP 420, which functions as a telephony controller. DSP 420 provides telephone connectivity to the client telephonic equipment (not shown) by converting between the VoIP format used for Internet telephony by Ethernet switch 407 and the digital format used by codecs 421 and 422.

DSP 420 connects to time-division multiplexing (TDM) bus 426. TDM bus 426, in turn, connects to codecs such as codecs 421 and 422. Codecs 421 and 422 convert between analog telephonic signals, which go to/from client telephonic equipment, and digital telephonic signals, which go to/from DSP 420. Codecs 421 and 422 are also used to detect phone off-hook conditions on their respective lines, and to notify control processor 409 upon such detection (connections not shown). Codecs 421 and 422 can be implemented, for example, using a Le792288 octal codec from Legerity, Inc. of Austin, Tex., which incorporates eight individual codecs.

Codec 421 transmits analog telephonic signals to/from PoE filter/transformer 411, and digital telephonic signals to/from TDM bus 426. PoE filter/transformer 411 functions as a subscriber line interface circuit (SLIC). PoE filter/transformer 411 connects to line card access switch (LCAS) relay 423, which in turn connects to RJ45 interface 412. LCAS relays 423 and 424 are adapted to inject a ring signal generated by ring generator 425 on their corresponding lines. Dashed arrow 425a indicates a connection from ring generator 425 to LCAS relay 423, as well as connections from ring generator 425 to additional LCAS relays (not shown). Control processor 409 controls the operation of ring generator 425.

Ethernet switch 407 connects to RJ45 interface 412 in a manner substantially similar to the connection of Ethernet switch 207 to RJ45 interface 212 of FIG. 2, but with the addition of LCAS relay 423 to the path between PoE filter/transformer 411 and RJ45 interface 412. LCAS relay 423 does not substantially alter the transmission of Ethernet data to/from RJ45 interface 412. PoE filter/transformer 411 includes a diplexing filter that splits incoming signals received from LCAS relay 423 based on frequency, with appropriate high-frequency, i.e., Ethernet, signals going to PHY 410 and appropriate low-frequency, i.e., telephonic, signals going to codec 421.

PoE filter/transformer 411 is further adapted to transmit to LCAS relay 423 the outgoing signals received from PHY 410 and/or codec 421. Only one pair of wires is required for a telephone line, thus only one wire pair, in this present embodiment, out of the four wire pairs coming in from LCAS relay 423, needs to be split by a diplexer in PoE filter/transformer 411. One of the four wire pairs that go from LCAS relay 423 to PoE filter/transformer 411 is split in two. Of the split wire pairs, one goes to codec 421 and the other joins the three non-split wire pairs to PHY 410. Thus one wire pair goes to codec 421 and four wire pairs go to PHY 410. In an alternative embodiment, additional wire pairs may be split by diplexing filters.

Ethernet switch 407 connects to RJ45 interface 415 via PHY 413, PoE filter/transformer 414, and LCAS relay 424 in substantially the same way as described above for the connection to RJ45 interface 412. DSP 420 connects to RJ45 interface 415 via codec 422, PoE filter/transformer 414, and LCAS relay 424 in substantially the same way as described above for the connection to RJ45 interface 412. Ethernet switch 407 and DSP 420 can be connected to one or more additional RJ45 interfaces (not shown) in substantially the same manner as described above.

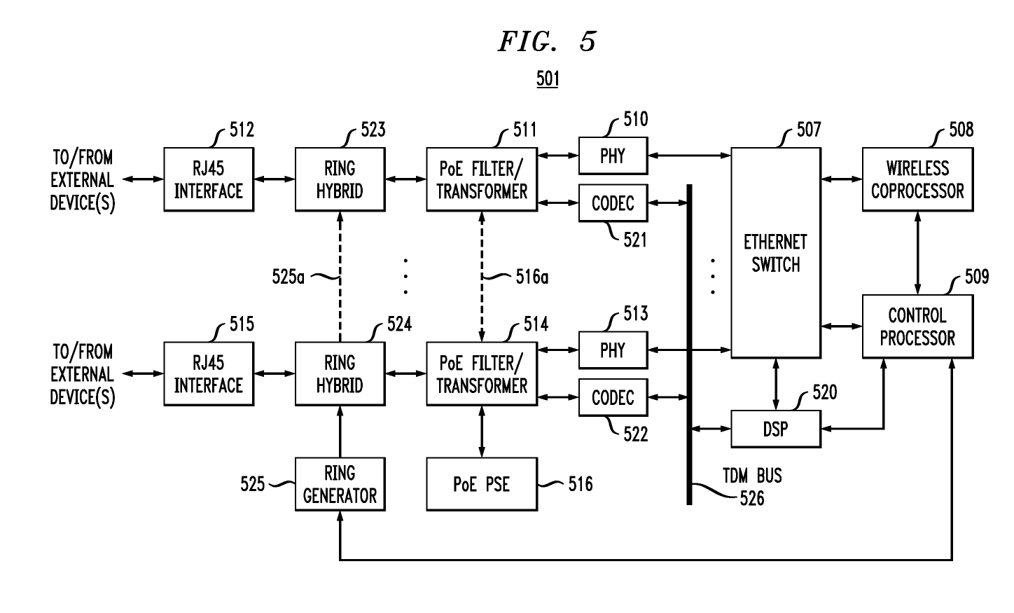

FIG. 5 shows a simplified block diagram of switching system 501, which can be used to implement switching system 301 of FIG. 3, in accordance with one embodiment of the present invention. Elements in FIG. 5 that are similar to elements in FIG. 4 have corresponding labels, but with different prefixes. Switching system 501 includes Ethernet switch 507, wireless coprocessor 508, control processor 509, and DSP 520, which operate similarly to the corresponding elements in FIG. 4.

Ethernet switch 507 and DSP 520 connect to RJ interfaces such as RJ45 interfaces 512 and 515 similarly to the manner in which the corresponding elements are connected in FIG. 4, but in place of LCAS relays 423 and 424, ring-hybrids 523 and 524, respectively, are used. Ring hybrids, such as ring-hybrids 523 and 524, support the injection of ring signals on their respective lines while avoiding disruption of Ethernet signals on the line, which disruption may occur with ring-signal injection by LCAS relays, such as LCAS relays 423 and 424 of FIG. 4.

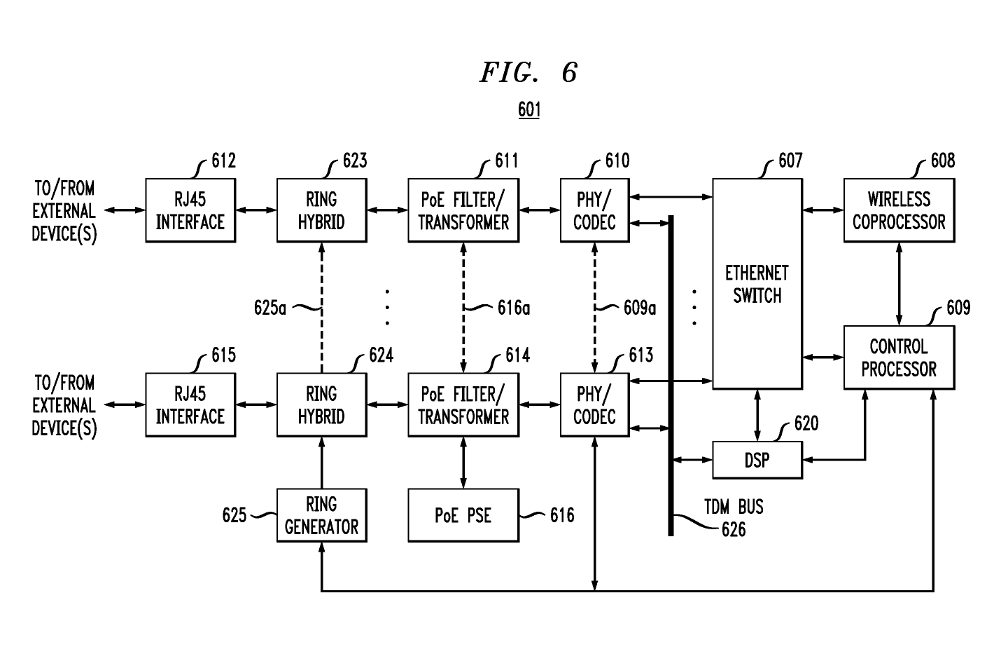

FIG. 6 shows a simplified block diagram of switching system 601, which can be used to implement switching system 301 of FIG. 3, in accordance with one embodiment of the present invention. Elements in FIG. 6 that are similar to elements in FIG. 5 have corresponding labels, but with different prefixes. Switching system 601 includes Ethernet switch 607, wireless coprocessor 608, control processor 609, and DSP 620, which operate similarly to the corresponding elements in FIG. 5. Ethernet switch 607 connects to RJ45 interfaces such as RJ45 interfaces 612 and 615 similarly to the manner in which the corresponding elements are connected in FIG. 5.

DSP 620 connects to RJ45 interface 612 via PHY/codec 610, which incorporates the functions of a physical-layer device and a codec, such as PHY 510 and codec 521 of FIG. 5. To the extent that physical-layer devices and codecs both have certain types of circuitry, such as A/D and D/A converters, they may share such circuitry if combined. This incorporation allows for fewer components, which typically helps reduce system costs. Dashed arrow 609a indicates a connection from control processor 609 to PHY/codec 610, as well as connections from control processor 609 to additional PHY/codecs (not shown). DSP 620 connects to TDM bus 626, which connects to PHY/codec 610, which in turn connects to PoE filter/transformer 611. PoE filter/transformer 611 connects to ring-hybrid 623, which in turn connects to RJ45 interface 612. DSP 620 connects to RJ interface 615 via TDM bus 626, PHY/codec 613, PoE filter/transformer 614, and ring-hybrid 624 in a similar manner.

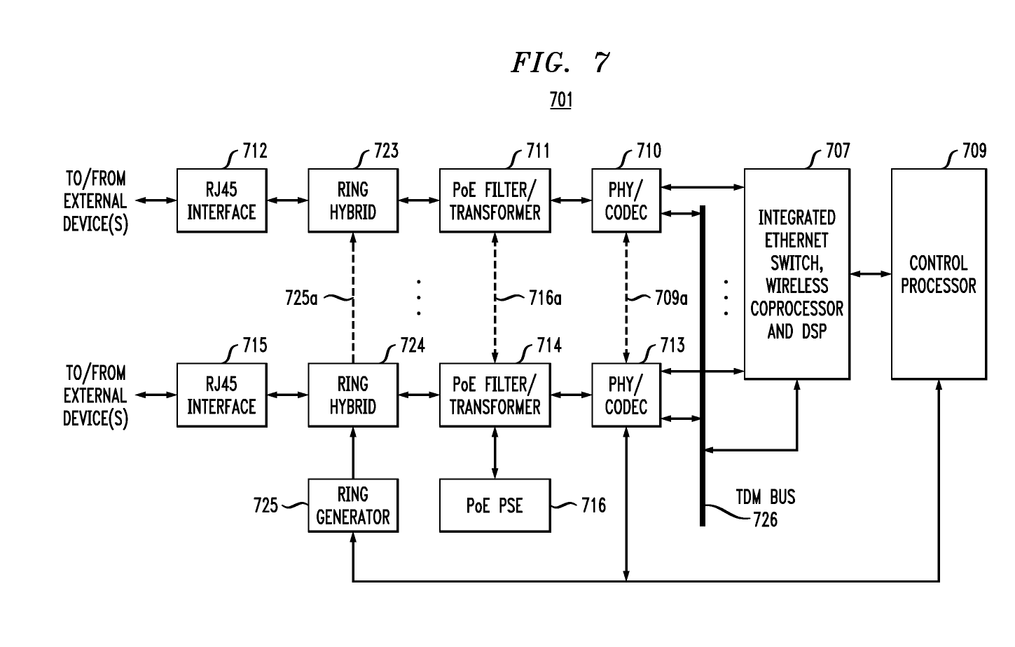

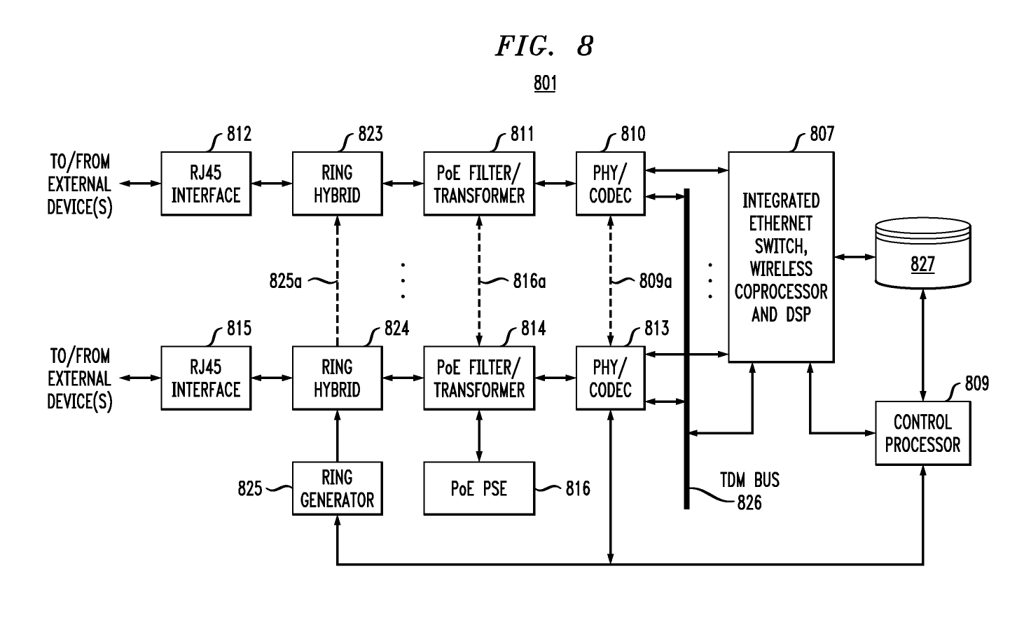

FIG. 7 shows a simplified block diagram of switching system 701, which can be used to implement switching system 301 of FIG. 3, in accordance with one embodiment of the present invention. Elements in FIG. 7 that are similar to elements in FIG. 6 have corresponding labels, but with different prefixes. Switching system 701 includes: (i) control processor 709, which is similar to control processor 609 of FIG. 6, and (ii) integrated Ethernet switch 707, which incorporates the functionality of an Ethernet switch, a DSP, and a wireless coprocessor, such as Ethernet switch 607, DSP 620, and wireless coprocessor 608 of FIG. 6. This integration allows for fewer components, which typically helps reduce system costs. Integrated Ethernet switch 707 connects to RJ45 interfaces such as RJ45 interfaces 712 and 715 similarly to the manner in which Ethernet switch 607 and DSP 620 of FIG. 6 connect to RJ45 interfaces such as RJ45 interfaces 612 and 615 of FIG. 6.

FIG. 8 shows a simplified block diagram of switching system 801, which can be used to implement switching system 301 of FIG. 3, in accordance with one embodiment of the present invention. Elements in FIG. 8 that are similar to elements in FIG. 7 have corresponding labels, but with different prefixes. Switching system 801 includes control processor 809 and integrated Ethernet switch 807, which are similar to the corresponding elements of FIG. 7. Switching system 801 further comprises database storage 827, which is connected to control processor 809 and integrated Ethernet switch 807. Database storage 827 is adapted to store data such as incoming and outgoing voicemail messages for telephones connected to switching system 801 via integrated Ethernet switch 807 and TDM bus 826. Database storage 827 may also provide local file-server capability. Integrated Ethernet switch 807 connects to RJ45 interfaces such as RJ45 interfaces 812 and 815 in substantially the same manner as integrated Ethernet switch 707 of FIG. 7 connects to RJ45 interfaces such as RJ45 interfaces 712 and 715.

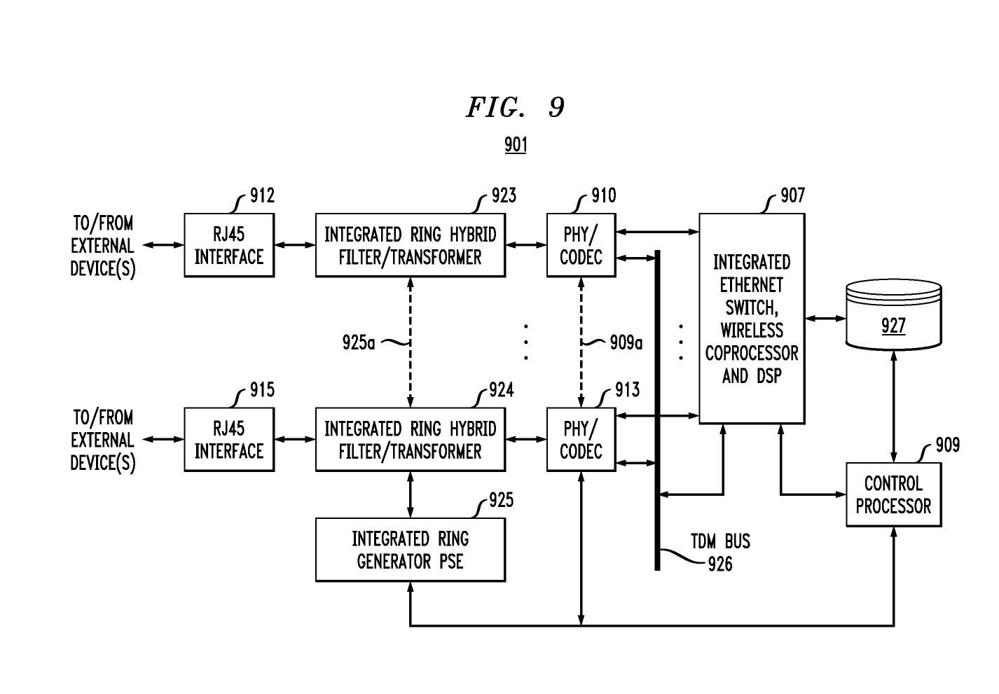

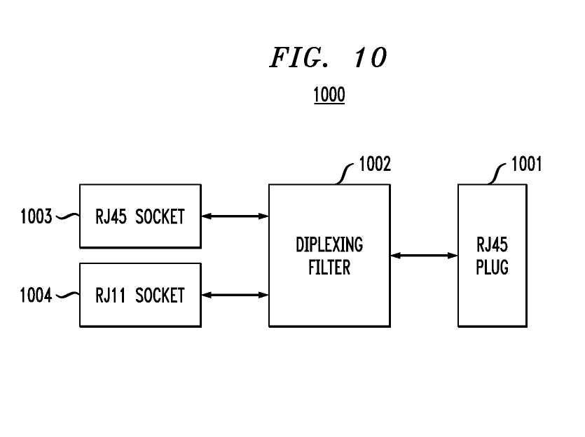

FIG. 9 shows a simplified block diagram of switching system 901, which can be used to implement switching system 301 of FIG. 3, in accordance with one embodiment of the present invention. Elements in FIG. 9 that are similar to elements in FIG. 8 have corresponding labels, but with different prefixes. Switching system 901 utilizes integrated ring-hybrid filter/transformer devices 923 and 924 in place of individual ring-hybrids and PoE filter/transformers. In addition, switching system 901 utilizes integrated ring generator PSE device 925 in place of separate ring generator and PSE devices. The integration of components allows for fewer components, which typically helps reduce system costs.

Integrated ring-hybrid filter/transformer devices 923 and 924 include triplexing filters that allow for the splitting of signals into DC voltages, low-frequency signals, and high-frequency signals. Signals incoming from RJ45 interface 912 to integrated ring-hybrid filter transformer 923 are split so that DC signals go to integrated ring generator PSE device 925, appropriate low-frequency, i.e., telephonic, signals go to the codec portion of PHY/codec 910, and appropriate high-frequency, i.e., Ethernet, signals go to the PHY portion of PHY/codec 910. Similarly, signals outgoing to RJ45 interface 912 are combined. Integrated ring-hybrid filter/transformer 924 functions similarly.

FIG. 10 shows splitter 1000, which may be used with an RJ45 socket, such as RJ45 socket 319 of FIG. 3, to provide connectivity to both a telephonic device, such as telephone 317 of FIG. 3, and an Ethernet device, such as workstation 302 of FIG. 3, thereby allowing two devices to simultaneously operate and share a single RJ45 socket. Splitter 1000 includes RJ45 plug 1001, diplexing filter 1002, and RJ45 socket 1003 and RJ11 socket 1004. RJ45 plug 1001 plugs into an RJ45 socket, such as RJ45 socket 319 of FIG. 3. Diplexing filter 1002 splits signals from RJ45 plug 1001 so that appropriate low-frequency signals go to RJ11 socket 1004 and appropriate high-frequency signals go to RJ45 socket 1003. RJ11 socket 1004 is adapted to connect to a telephonic device. RJ45 socket 1003 is adapted to connect to an Ethernet device. Diplexing filter 1002 also combines incoming signals received from RJ45 socket 1003 and RJ11 socket 1004 for provision to RJ45 plug 1001.

In an alternative embodiment, splitter 1000 is part of the wall socket, such as socket 319 of FIG. 3, wherein, for example, RJ45 plug 1001 is connected to infrastructure wiring 319a.

In an alternative embodiment (not shown), splitter 1000 is adapted to support a PoE device connected to RJ45 socket 1003 by using a triplexing filter in place of diplexing filter 1002, wherein the triplexing filter transmits DC and appropriate high-frequency signals to RJ45 socket 1003 and appropriate low-frequency signals to RJ11 socket 1004.

In an alternative embodiment (not shown), diplexing filter 1002 is replaced by a node connecting RJ45 plug 1001 to RJ45 socket 1003 and RJ11 socket 1004. Diplexing filter 1002 may be unnecessary since the frequencies of telephonic communication signals and Ethernet communication signals are sufficiently divergent such that there is no significant interference between the two.

In an alternative embodiment (not shown), splitter 1000 employs two RJ45 sockets, i.e., an RJ45 socket replaces RJ11 socket 1004, wherein the replacing RJ45 socket is appropriately designated for telephonic connections with an RJ11 plug.

Embodiments of the present invention have been described as combinations of Ethernet, PoE, and telephone devices. However, embodiments of the present invention may include combinations of Ethernet and telephone devices that exclude PoE devices.

The present invention has been described using, as an example, an Ethernet network standard. However, any suitable packet-switched network standard may be employed. The present invention has been described as using a wireless coprocessor. However, a wireless coprocessor is not required. A wireless coprocessor may be absent if, for example, no wireless devices are used in the network, or no firewall is used for wireless traffic.

The terms “connect,” “connected,” or “connection” as used herein refer to a linking that allows the transmission of signals so as to support switched-packet network services and/or telephonic services. The transmission (1) may be through one or more media, (2) may be either unidirectional or bidirectional, and (3) may be direct or indirect, in which case the linking includes one or more intermediary devices. For example, transmission may take place via electrically conductive elements, radio-frequency (RF) wireless signals, infra-red (IR) wireless signals, optical fibers, capacitive coupling, magnetic coupling, or any other suitable means of signal transmission.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A network switching system (e.g., 401) comprising:
control circuitry adapted to:
provide packet-switched-network services to one or more network client devices (e.g., 302, 303, 304); and
provide analog-telephone services to one or more telephonic client devices (e.g., 317, 318); and
one or more ports, each adapted to connect to one or more client devices, wherein at least one port is adapted to support provision by the control circuitry of both packet-switched-network services and analog-telephone services.

2. The invention of claim 1, wherein the network switching system is adapted to provide electrical power to at least one powered network client device.

3. The invention of claim 2, wherein the network switching system is adapted to provide the electrical power in accordance with a Power-over-Ethernet standard.

4. The invention of claim 1, wherein the packet-switched-network services are compatible with an Ethernet standard.

5. The invention of claim 1, wherein the network switching system is adapted to provide simultaneous connectivity on the at least one port to both a network client device and a telephonic client device.

6. The invention of claim 5, wherein:
the network client device is a powered network client device; and
the network switching system is adapted to provide electrical power to the powered network client device.

7. The invention of claim 5, wherein the at least one port is connected to the client devices via a splitter comprising:
a first interface adapted to connect to the network client device;
a second interface adapted to connect to the telephonic client device; and
a third interface connected to the first and second interfaces, wherein the third interface is adapted to connect to the at least one port.

8. The invention of claim 7, wherein the splitter further comprises a diplexing filter, wherein the third interface connects to the first and second interfaces via the diplexing filter.

9. The invention of claim 1, wherein the control circuitry comprises:
a network switch (e.g., 407); and
a digital signal processor (DSP) (e.g., 420) connected to the network switch.

10. The invention of claim 9, wherein the network switching system comprises:
a data bus (e.g., 426) connected to the DSP; and
a ring generator (e.g., 425) adapted to support injection of a ring signal on the at least one port.

11. The invention of claim 10, wherein the at least one port comprises:
a physical-layer device (PHY) (e.g., 410) connected to the network switch;
a codec (e.g., 421) connected to the DSP;
a transformer link (e.g., 411) connected to the PHY and the codec;
a ring injector (e.g., 423, 523) connected to the transformer link and to the ring generator; and
a port interface (e.g., 412) connected to the ring injector.

12. The invention of claim 11, wherein:
the PHY is adapted to convert between analog and digital signals;
the codec is adapted to convert between analog and digital signals;
the transformer link is adapted to filter signals based on frequency;
the ring generator is adapted to inject the ring signal; and
the port interface is adapted to couple to a communication cable.

13. The invention of claim 9, wherein the network switching system further comprises a wireless coprocessor connected to the network switch, wherein the wireless coprocessor is adapted to process data from one or more wireless network client devices connected to one or more of the ports.

14. The invention of claim 13, wherein the network switch, the DSP, and the wireless coprocessor are integrated as a single device.

15. The invention of claim 10, wherein the network switching system further comprises a database adapted to support telephonic service features.

16. The invention of claim 11, wherein the PHY and the codec are integrated as a single device.

17. The invention of claim 11, wherein the transformer link and ring injector are integrated as a single device.

18. The invention of claim 11, wherein the network switching system further comprises power sourcing equipment (PSE) adapted to provide electrical power to a powered network client device via the transformer link of the at least one port.

19. The invention of claim 11, wherein the ring injector is an LCAS relay.

20. The invention of claim 11, wherein the ring injector is a ring hybrid.
